(19) United States
(12) Patent Application Publication
(10) Pub. No.: US 2013/0269526 A1
(43) Pub. Date: Oct. 17, 2013

(54) METHODS AND APPARATUS FOR CARBON DIXOIDE CAPTURE

(71) Applicants: STEVEN RAYMOND LUSTIG, Landenberg, PA (US); F. Glenn Gallagher, Wilmington, PA (US); Manish S. Kelkar, Wilmington, DE (US)

(72) Inventors: STEVEN RAYMOND LUSTIG, Landenberg, PA (US); F. Glenn Gallagher, Wilmington, PA (US); Manish S. Kelkar, Wilmington, DE (US)

(73) Assignee: E I DU PONT DE NEMOURS AND COMPANY, Wilmington, DE (US)

(21) Appl. No.: 13/611,692

(22) Filed: Sep. 12, 2012

Related U.S. Application Data
(60) Provisional application No. 61/533,603, filed on Sep. 12, 2011.

(51) Int. Cl. B01D 53/14

(52) U.S. Cl. CPC B01D 53/1475
USPC 95/180; 96/242

(57) ABSTRACT

Described are methods and apparatus for the selective removal of CO₂ from a mixture of gases. The method comprises contacting a first gaseous mixture containing CO₂ in an absorber with an absorbent having substantial selectivity for CO₂, thereby forming a second mixture of absorbed CO₂ and absorbent. After separating any nonabsorbed gases from the second mixture of CO₂ and absorbent, the second mixture enters a separator wherein the CO₂ is released from the absorbent. The absorbent is recycled back to the absorber to start the process over. The released CO₂, is then compressed in one or more stages. Each stage provides a compression step to heat the released CO₂, followed by a cooling step. The heat generated during the cooling of the CO₂ is captured by intercoolers and recycled to operate the capture and separating process in a substantial manner, if not entirely.

### TECHNICAL FIELD

This invention relates to energy efficient methods and related apparatus that enable the separation of carbon dioxide from a mixture of gases for further use, storage rather than venting to the atmosphere.

### BACKGROUND

There is increasing interest in methods to selectively remove or capture carbon dioxide (CO₂) from many different gaseous mixtures. Although CO₂ is a component of many gas streams such as natural gas and effluent gases, elevated levels of CO₂ have undesirable consequences. There is much global interest in reducing CO₂ emissions from gaseous mixtures, such as combustion exhaust, as a means to inhibit or slow global warming. CO₂ can be removed or captured by many means, such as physical or chemical absorption of the gas by a liquid or solid.

Currently, a common method of carbon dioxide capture from process streams in industrial complexes involves the use of absorbents such as aqueous solutions of alkanolamines, but this is usually applied on a small scale. The process has been used commercially since the early 1930s (see, for example, Kohl and Nielsen, Gas Purification, 5th Edition, Gulf Publishing, Houston Tex., 1997), and is based on the reaction of a weak base (alkanolamine) with a weak acid (CO₂) to produce a water-soluble salt. This reaction is reversible, and the equilibrium is temperature dependent. Among conventional alkanolamines, monoethanolamine (MEA) is considered an attractive solvent at low partial pressures of CO₂ because it reacts at a rapid rate and the cost of the raw materials is low.

One typical situation in which CO2 capture occurs is in the separation and removal of carbon dioxide from other flue gases coproduced as electrical power generating plants burn carbon-based fuels to produce electricity. Typically the carbon dioxide is separated from other gases such as nitrogen, sulfur dioxide or oxygen, which can be accomplished using absorbents such the alkanolamines mentioned above. This separated carbon dioxide may be either utilized for other purposes, or sequestered into a reservoir, and the use or sequestration of the carbon dioxide prevents its undesirable emission into the environment. Reservoir sequestration may only be practical, however, when the carbon dioxide gas is compressed, typically to about 150 atmospheres.

In the case of a generating plant, the prevention of carbon dioxide emission via capture and sequestration can represent a large, parasitic diversion of the electrical power being generated if the capture and sequestration (e.g. absorption and compression) operations are supported by the same power output originally intended for useful commercial and residential purposes. In such a type of carbon-fuel fed power generation process, it is thus desired to both separate and compress the carbon dioxide whilst diverting the smallest amount of power generated away from the useful commercial and residential purposes. Even in the case where CO2 is not obtained from generating plant emissions, and where separation and compression are thus not being driven by simultaneously-generated electrical power, there is a need for improved efficiency in the operation.

There are technologies that are based on the diversion of some of the heat generated in a CO2 compression step toward the generation of more power to operate additional compression steps. However, a need nevertheless remains for methods and apparatus capable of providing low-cost, high-capacity methods of CO₂ capture and sequestration.

### SUMMARY

In one embodiment, there is provided herein a method of separating CO2 from a first mixture containing CO2 and other gases, whereby the method comprises the steps,

(a) contacting in an absorber, the first mixture of gases with an absorbent material that absorbs the CO₂ thereby separating the CO₂ from the first mixture and forming a second mixture comprising absorbed CO₂ and the absorbent material;

(b) heating in a stripper, the second mixture to a temperature sufficient to separate the CO₂ from the absorbent material to form released CO₂ and used absorbent material;

(c) increasing the pressure of the released CO₂ to a first pressure and a first temperature;

(d) cooling the released CO₂ of step (c) to a lower second temperature and extracting heat from the CO₂ during the cooling;

(e) recycling the used absorbent material back to the absorber; and

(f) applying the heat extracted during the cooling of the released CO₂ to provide at least a substantial portion of the heating requirements for operating the stripper and/or the absorber.

The term “substantial portion” signifies a percentage of the heating or energy requirements for operating the stripper, absorber or other device (e.g., absorption cooler) that is provided for by the cooling of the released CO2. As encompassed by the invention disclosed herein, a substantial portion may be greater than or equal to 50%, or greater than or equal to 60%, or even greater than or equal to 70%, or preferably greater than or equal to 80%, or more preferably greater than or equal to 90%, or even more preferably greater than or equal to 100%, of the heating or energy requirements for operating the aforementioned devices.

In another embodiment, there is provided herein a method of separating CO2 from a first mixture containing CO2 and other gases, whereby the method comprises the steps,

(a) contacting the first mixture of gases with an absorbent that absorbs the CO₂ thereby separating it from the first mixture, thereby forming a second mixture comprising absorbed CO₂ and the absorbent;

(b) applying an amount of heat Qₒᵤₜ, at a coefficient of performance (“COP”), to cool one or more of the first mixture, the absorbent and/or the second mixture;

(c) applying an amount of heat Qᵢₙ to heat the second mixture to separate the absorbed CO₂ from the absorbent to form released CO₂; and

(d) increasing the pressure of the released CO₂, to a pressure whereby, when the released CO₂ is cooled to reduce its temperature and to extract heat therefrom, the extracted heat (Qₐᵥₐᵢₗ) satisfying the equation

Qₐᵥₐᵢₗ>F×(Qᵢₙ−Qₒᵤₜ/COP);

wherein F is a percentage, greater than or equal to 50%, or greater than or equal to 60%, or even greater than or equal to 70%, or preferably greater than or equal to 80%, or more preferably greater than or equal to 90%, or even more preferably greater than or equal to 100%.

In a further embodiment, there is provided herein an apparatus for separating CO2 from a first mixture containing CO2 and other gases comprising,

(a) an absorber comprising an absorbent material for absorbing CO₂, wherein the CO₂ is separated from the first mixture thereby forming a second mixture comprising absorbed CO₂ and the absorbent material;

(b) a separator for heating the second mixture to a temperature sufficient for releasing the absorbed CO₂ from the absorbent material thereby providing released CO₂;

(c) at least one compressor to compress the released CO₂ thereby increasing the pressure and temperature of the CO₂;

(d) at least one cooler for reducing the temperature of the CO₂ to provide cooled CO₂, and extracting heat therefrom; and

(e) a thermal energy transfer medium for applying the heat extracted from the cooled CO₂ to one or more of the absorber or the separator.

### BRIEF DESCRIPTION OF THE DRAWINGS

FIG. 1. Schematic of the carbon capture system unit operations (white) and the carbon dioxide compression stages with intercooling (blue).

FIG. 2. A Temperature-Entropy plot of carbon dioxide taken from RefProp showing the seven states in a 3 stage compression train with intercooling.

FIGS. 3A and 3B (left to right, respectively). Space map of net energy illustrated for variables carbon dioxide—absorbent heats of reaction and absorbent heat capacities. The black regions indicate negative net energy and the gray and white regions indicate positive net energy.

FIG. 4 shows an embodiment of an absorption cooler.

### DETAILED DESCRIPTION

In the context of the present disclosure, the term “absorbent material,” or solely “absorbent” refers to any substance or material to which CO₂ binds, or is absorbed to. It follows therefore that absorbed CO₂ is the form of CO₂ that is in contact with, or has reacted with, the absorbent; such CO₂ may be referred to “captured,” “reacted,” “sequestered,” “absorbed” or “bound.” Persons of ordinary skill in the art will recognize that there may be more than one suitable mechanism by which the CO₂ can be absorbed to the absorbent material.

In the context of separating the contacted (i.e., “captured,” “reacted,” “sequestered,” “absorbed” or “bound”) CO₂ from the absorbent, the term “separating” is synonymous with “desorbing,” “recreating,” “reforming,” “stripping” or “releasing” the CO₂ from the absorbent. It should be noted that absorbent material from which CO₂ has been stripped or released is referred to herein as “stripped absorbent,” “stripped absorbent material,” “used absorbent” or “used absorbent material.” This used absorbent may be completely devoid of CO2, or it may contain a small amount of CO₂ from a previous cycle, which is too small to be useful. This used absorbent is then recycled by contacting it with a fresh amount of first gaseous mixture comprising CO₂.

In contrast, “fresh absorbent” or “new absorbent” refers to absorbent material that is not recycled; it has not yet been contacted by the gaseous mixture comprising CO₂ and subsequently stripped of its load. In other words, new or fresh absorbent material has not yet absorbed any CO₂ by passing through the absorber.

Used absorbent is recycled back to the absorber for use in additional cycles of CO₂ absorption and stripping. Therefore, after a high temperature stripping step the used absorber is cooled down to the temperature of the absorber by passing through a cooling means, such as an absorption cooler (which can also be referred to as an “absorption chiller”). Once properly cooled the used absorber is contacted by an amount of additional fresh or new first mixture of gases containing CO₂ (i.e., a gaseous mixture comprising CO₂).

Cooling of the CO₂ is performed in a cooling device referred to herein as a “cooler,” “intercooler,” or “interstage cooler.” In the method described herein, at least one cooler receives CO₂ that has been heated by compression in a compressor.

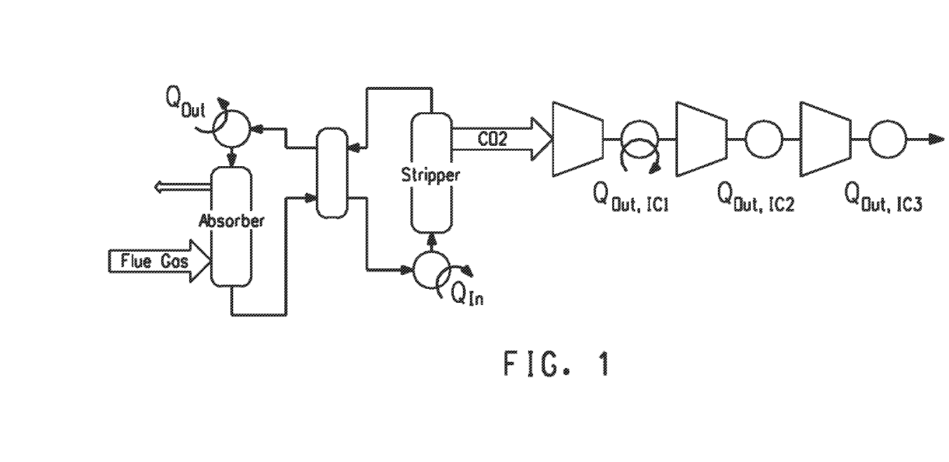

In one embodiment, there is provided herein methods and apparatus for carbon capture wherein power need only be supplied from an external source for the purpose of compressing captured carbon dioxide. External power is not directly or substantially required for other aspects of the process such as absorption or separation. With the chemical absorbents that are used herein, a carbon capture process can be powered substantially if not exclusively from interstage coolers (or intercoolers) placed after each compressor, when either one or a plurality of compressors is used in the compression process. FIG. 1 illustrates a non-limiting embodiment wherein three separate compression steps are each followed by a separate cooling step. The inventive method may comprise a single compression step followed by a single cooling step; alternatively, a plurality of compression steps, each followed by a cooling step, is also encompassed by the invention.

Carbon dioxide is naturally heated by compression. As the carbon dioxide temperature rises, substantially more power is required to compress the gas, therefore it is consequently advantageous to cool the carbon dioxide (after each compression stage, for example, in a multi-stage compression process). Even when a compression operation is isentropic or polytropic, it is found in the methods and apparatus herein that sufficient heat can be extracted from either some or all of the intercoolers to operate the capture process substantially if not entirely. This approach provides a clear boundary for desorption energy use, i.e. the waste heat from compressing the CO₂ from atmospheric pressure to pipeline pressure (about 150 atm).

One embodiment of the method described herein is illustrated in FIG. 1. A gaseous mixture, such as flue gas, that comprises CO₂ is fed into an absorber to capture the carbon dioxide contained therein into or onto an absorbent. The other gases in the mixture are passed through the absorber and are emitted, while the loaded absorbent is pumped into a stripper to strip or release the carbon dioxide gas from the absorbent. The absorbent having been stripped of its CO₂ is recycled back into the absorber to complete its cycle. There is a heat exchanger to permit the absorbent leaving the stripper to exchange its heat with the lower temperature loaded absorbent leaving the absorber. The captured and released carbon dioxide exiting the stripper is compressed in either one or multiple stages (for this particular embodiment, three stages are shown in FIG. 1). For multiple stages it is advantageous that each stage has the same compression ratio. A cooling step (performed in an intercooler) is placed after each compression stage (performed in a compressor) when more than one compression/cooling cycle is used. Mass and energy balances provide expressions for the amount of thermal energy required for heating the fat stream (i.e., the stream comprising CO₂ bound to the absorbent) entering the stripper, Q_{In}, and cooling the lean stream (i.e., the stream comprising the stripped absorbent) entering the absorber, Q_{Out}, as follows:

$${Q}_{In} = ( - Δ {H}_{RXN} ) {w}_{In}^{{CO}_{2}} + ( \frac{1 - {w}_{STR}^{{CO}_{2}}}{{w}_{ABS}^{{CO}_{2}} - {w}_{STR}^{{CO}_{2}}} ) {w}_{In}^{{CO}_{2}} {C}_{p , ABS} [ {T}_{STR} - \frac{( 1 - {w}_{STR}^{{CO}_{2}} ) {C}_{p , ABS} {T}_{ABS} + ( 1 - {w}_{ABS}^{{CO}_{2}} ) {C}_{p , STR} ( {T}_{STR} - {T}_{X} )}{( 1 - {w}_{STR}^{{CO}_{2}} ) {C}_{p , ABS} + ( 1 - {w}_{ABS}^{{CO}_{2}} ) {C}_{p , STR}} ] \\ {Q}_{Out} = ( - Δ {H}_{RXN} ) {w}_{In}^{{CO}_{2}} + ( \frac{1 - {w}_{STR}^{{CO}_{2}}}{{w}_{ABS}^{{CO}_{2}} - {w}_{STR}^{{CO}_{2}}} ) {w}_{In}^{{CO}_{2}} {C}_{p , STR} [ \frac{( 1 - {w}_{STR}^{{CO}_{2}} ) {C}_{p , ABS} {T}_{ABS} + ( 1 - {w}_{ABS}^{{CO}_{2}} ) {C}_{p , STR} ( {T}_{STR} - {T}_{X} )}{( 1 - {w}_{STR}^{{CO}_{2}} ) {C}_{p , ABS} + ( 1 - {w}_{ABS}^{{CO}_{2}} ) {C}_{p , STR}} + {T}_{X} - {T}_{ABS} ]$$

Here ΔH_{RXN} is the heat of absorption for the carbon dioxide reaction with the absorbent; w_{ABS}^{CO}^{₂} and w_{STR}^{CO}^{₂} are the weight fractions of carbon dioxide in the absorbent in the absorber and stripper conditions, respectively; C_{p,ABS} and C_{p,STR} are the heat capacities of the absorbent in the absorber and stripper conditions, respectively; T_{ABS} and T_{STR} are the operating temperatures in the absorber and stripper, respectively; Tₓ is the minimum approach temperature for the central heat exchanger, usually around 5 to 10° C.; and w_{In}^{CO}^{₂} is the weight fraction of carbon dioxide in the flue gas entering the absorber. The pressure, P_{ABS}, of carbon dioxide entering the absorber is nominally about 1 atm (0.1 MPa) and the pressure, P_{STR}, leaving the stripper is well predicted by the Clausius-Clapeyron relationship.

$${P}_{STR} = {P}_{ABS} exp [ \frac{- Δ {H}_{RXN}}{R} ( \frac{1}{{T}_{ABS}} - \frac{1}{{T}_{STR}} ) ]$$

Here R is the universal gas constant. The carbon dioxide is typically compressed from P_{ABS} typically to about 150 atm (15.1 MPa) for sequestration storage or other use.

In a non-limiting illustration, a three-stage compression system as shown above in FIG. 1, as the captured carbon dioxide leaves the stripper it is first isentropically compressed to a first increased pressure and first higher temperature. The heated compressed CO₂ is then cooled in an intercooler back to the temperature of the stripper. This cycle of compression followed by cooling is exemplified in FIG. 1 with three cycles of compression and cooling. This heat from the intercooler is returned to the absorber and stripper process units. The compression and intercooling steps in this embodiment are repeated twice more for a total of three cycles. It should be readily appreciated that persons of ordinary skill in the art can provide for multiple stage compression systems that employ virtually any number of compression-cooling cycles.

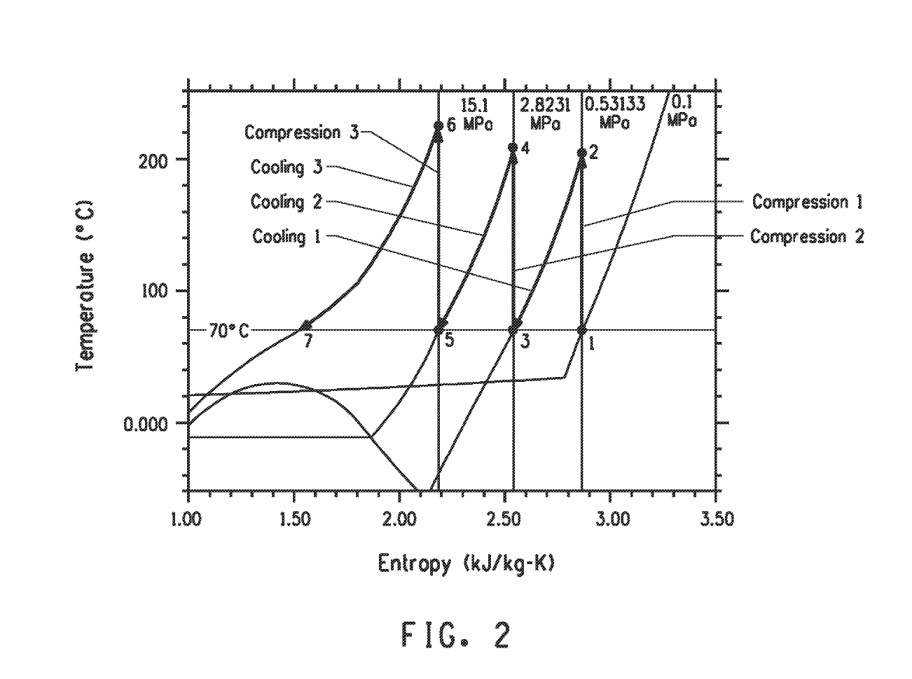

The seven thermodynamic states involving the carbon dioxide in this embodiment are set forth in Table 1 and are graphically represented in FIG. 2. These illustrative data are obtained assuming that cooling is done to about 70° C. while the carbon dioxide is compressed in three stages from approximately 1 atm to approximately 150 atm, the compression ratio of each stage being equal. State 1 is the state exiting the stripper, which is about 0.1 MPa, 70° C. Subsequent compression and cooling stages cycle the temperature between about 70° C. and approximately 205° C.-220° C. at pressures of about 0.1, 0.5, 2.8 and 15.1 MPa. The total thermodynamic work, W_{compress}, required to compress the carbon dioxide is measured by the enthalpies at the various states, i.e.

W_{compress}=H₂−H₁+H₄−H₃+H₆−H₅

The total available heat, Qₐᵥₐᵢₗ, extracted from the intercoolers is also measured by the enthalpies at the various states, i.e.

Qₐᵥₐᵢₗ=H₂−H₃+H₄−H₅+H₆−H₇

The thermodynamic properties for each of these seven states are tabulated below:

TABLE 1

| | Temperature | Pressure | Density | Enthalpy | Entropy |
|---|---|---|---|---|---|
| | (° C.) | (MPa) | (kg/m³) | (kJ/kg) | (kJ/kg-K) |
| 1 | 73.000 | 0.10000 | 1.5338 | 547.78 | 2.8696 |
| 2 | 210.65 | 0.53133 | 5.8396 | 677.41 | 2.8696 |
| 3 | 73.000 | 0.53133 | 8.2580 | 544.84 | 2.5481 |
| 4 | 213.72 | 2.8231 | 31.407 | 672.78 | 2.5481 |
| 5 | 73.000 | 2.8231 | 47.378 | 528.15 | 2.1977 |
| 6 | 226.26 | 15.000 | 174.07 | 647.72 | 2.1977 |
| 7 | 73.000 | 15.000 | 479.60 | 391.19 | 1.5663 |

Thus in this illustration the total thermodynamic work required to compress the carbon dioxide is about 377 J/g and the total available heat from the intercoolers is about 534 J/g.

The intercooling heat can be diverted into two uses. The first use is to provide at least a substantial portion of, or even the entire, heating requirement of the stripper to release the absorbed carbon dioxide from the absorbent. This heating requirement is shown as Q_{In} in FIG. 1. This use is realized by passing part of the intercooler heat into the stripper directly according to the amount required, Q_{In}. The second use is to operate an absorption cooler that converts the intercooler heat into a cooling capacity, which provides a substantial portion of, or the entire, cooling requirement of the absorber. Actual absorption coolers do not convert heat into cooling perfectly, they operate with a certain thermodynamic efficiency called the COP, coefficient of performance. The COP is defined as the ratio of the cooling energy provided by the cooler and the input heat supplied to the cooler. In following this illustration, an absorption cooler accepting heat at temperatures around 70° C. and cooling a stream to about 35° C. will operate with a COP just slightly less than unity, nominally about 97% using conventional aqueous lithium bromide absorption cooling media. Other energy required to operate the absorption cooler is considered nominally minor.

Therefore this invention defines carbon capture absorbents with thermodynamic properties described herein such that the total heat available from the compression intercoolers exceeds the heat requirements for the absorption and stripper operations. This requirement can be described by defining the net energy, E_{NET}, and requiring that it be positive.

$${E}_{NET} ≡ {Q}_{avail} - {Q}_{in} - \frac{{Q}_{out}}{COP} \geq 0$$

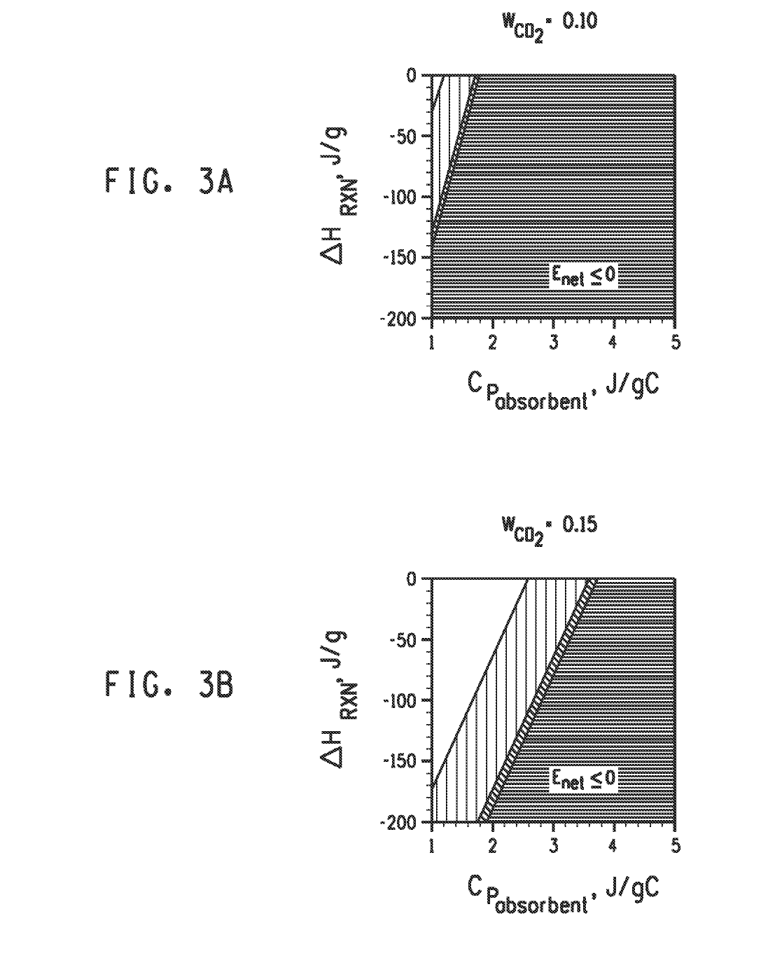

The invention disclosed herein further encompasses absorbents such that the heat available completely meets, substantially meets, just meets or nearly meets the heat requirements. The positive net energy requirement is illustrated in FIGS. 3A and 3B. In both cases the absorber is operated at 40° C. and 1 atm, and the stripper is operated at 70° C. The lean absorbent stream contains approximately 2 wt % carbon dioxide. The rich absorbent stream contains approximately 10 wt % and 15 wt % carbon dioxide in FIGS. 3A and 3B, respectively. Both cases indicate that absorbents having the appropriate ranges of heats of reaction with carbon dioxide and heat capacity will result in a net energy that is positive. In these cases the heat requirements of the absorber and stripper can be met entirely by the total heat available from the compression intercooling.

Thus, in one nonlimiting embodiment of this invention, as shown in the aforementioned FIG. 1, flue gas is fed into an absorber to capture the carbon dioxide into an absorbent. The coproduced gases pass through the absorber and are emitted, while the loaded absorbent is pumped into a stripper to release the carbon dioxide gas from the absorbent. The stripped absorbent is recycled back into the absorber to complete its cycle. For improved efficiency there is a heat exchanger to permit the absorbent leaving the stripper to exchange its hot temperature with the cooler loaded absorbent leaving the absorber. The captured carbon dioxide exiting the stripper is compressed in three stages from about 1 atm to about 150 atm, each stage having the same compression ratio with intercoolers placed after each stage. As the captured carbon dioxide leaves the stripper it is first isentropically compressed to a first increased pressure and higher temperature when it is then cooled by the intercooler back to the temperature of the stripper. This heat from the intercooler is returned to the absorber-stripper capture process units. The compression and intercooling steps are repeated twice.

The intercooling heat is diverted into two uses. The first use is to provide the entire heating requirement of the stripper to release the absorbed carbon dioxide from the absorbent. The second use is to operate an absorption cooler which converts the intercooler heat into a cooling capacity which provides the entire cooling requirement of the absorber. About 90% of the intercooler heat provides the energy required to run the absorber and stripping operations, while the remaining 10% of the intercooler heat provides energy for miscellaneous functions such as electricity for running office and plant lighting, computerized measurement and control systems, small fluid pumps, site safety and security systems and other minor electrical systems.

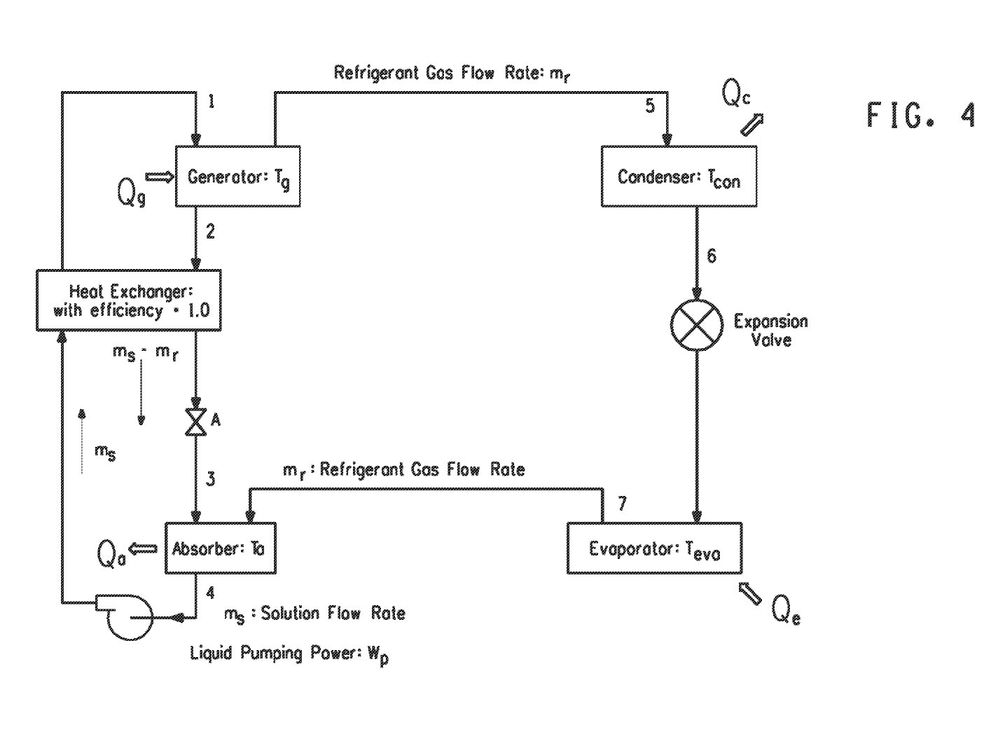

An absorption chiller to cool the flue gas, the absorbent and/or the mixture formed by the absorption of CO2 into the absorbent is known in the art. Suitable varieties of chillers would include (a) an absorber that forms a mixture of a mixture of a refrigerant and an absorbent; (b) a generator that receives the mixture from the absorber and heats the mixture to separate refrigerant, in vapor form, from the absorbent, and increases the pressure of the refrigerant vapor; (c) a condenser that receives the vapor from the generator and condenses the vapor under pressure to a liquid; (d) a pressure reduction device through which the liquid refrigerant leaving the condenser passes to reduce the pressure of the liquid to form a mixture of liquid and vapor refrigerant; (e) an evaporator, located in proximity to the object, medium or space to be cooled, that receives the mixture of liquid and vapor refrigerant that passes through the pressure reduction device to evaporate the remaining liquid to form refrigerant vapor; and (f) a conduit that passes the refrigerant vapor leaving the evaporator to the absorber. An illustrative example of a suitable chiller is shown in FIG. 4. Examples of suitable absorbents and refrigerants for use in a chiller to provide cooling to a CO₂ absorber are further described in U.S. Patent Application Publications 2006/0197053 and 2007/0019708, each of which is by this reference incorporated in its entirety as a part herein for all purposes.

Absorbents suitable for use herein have useful thermodynamic properties, such as heat capacity, heat of reaction with carbon dioxide absorption, equilibrium carbon dioxide concentration in the absorber conditions, equilibrium carbon dioxide concentration in the stripper conditions and overall chemical stability. In addition, the absorbent is stable to the chemical and thermal working environments in the absorber and stripper.

Examples of suitable absorbents for use herein are contained in the compositions set forth below. In the description of those compositions, the following definitional structures are provided to clarify the terminology as employed therein:

An “alkyl” group or radical is monovalent (i.e. having a valence of one) and is represented by the formula CₙH₂ₙ₊₁.

A “hydroxyalkyl” group or radical is monovalent (i.e. having a valence of one) and is represented by the formula HO(R′)ₙ.

An “alkoxyalkyl” group or radical is monovalent (i.e. having a valence of one) and is represented by the formula (CₙH₂ₙ₊₁)O(R′)ₘ.

An “aminoalkyl” group or radical is monovalent (i.e. having a valence of one) and is represented by the formula H₂N(R′)ₙ.

An “alkylaminoalkyl” group or radical is monovalent (i.e. having a valence of one) and is represented by the formula (CₙH₂ₙ₊₁)NH(R′)ₘ.

In the above formulae, n and m are each independently a value in the range of 1˜20, 1˜10, 1˜8, 1˜4, 2˜20, 2˜10, 2˜8, 3˜10, 3˜6, 4˜10, or 4˜8, wherein the endpoints of each range are included in said range. The R′ portions of any of the above described groups or radicals may independently be a C₁ to C₆ alkyl group.

Examples of suitable absorbents for use herein are included in one or more of the compositions represented by the structure of Formula I, Formula II, Formula III, Formula IV or Formula V, which compositions comprise a partially neutralized vicinal diamine, triamine or tetramine:

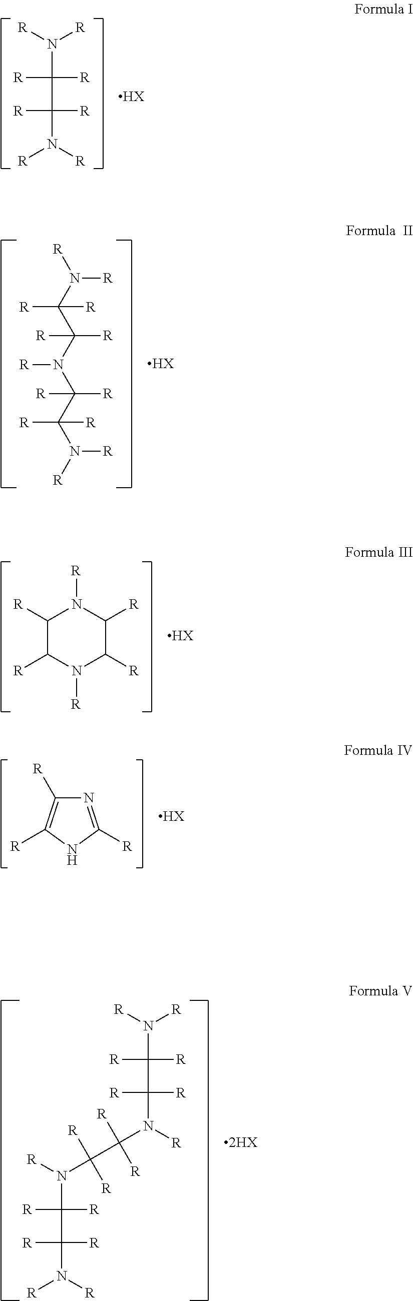

wherein

each R is independently H; alkyl of the formula CₙH₂ₙ₊₁; hydroxyalkyl of the formula HO(R′)ₙ; aminoalkyl of the formula H₂N(R′)ₙ; alkylaminoalkyl of the formula (CₙH₂ₙ₊₁)NH(R′)ₘ; or, alkoxyalkyl of the formula (CₙH₂ₙ₊₁)O(R′)ₘ; wherein R′ comprises a C₁ to C₆ alkyl group; and each R can independently form one or more alicyclic rings with another R; and wherein

HX is an acid with an acidic proton that forms a partially neutralized salt of the amine.

In one embodiment, alicyclic rings are formed in a Formula I, II or V compound by R groups that are not bonded to a terminal nitrogen; the result of which being that, in one of the embodiments of a Formula I composition, the amine is cyclohexanediamine (1,2-diaminocyclohexane). In another embodiment of a Formula I composition, however, the amine can be an ethylene diamine.

An ethylene diamine can be prepared by treating ethylene dichloride, ethylene oxide or ethanol amine with aqueous or liquid ammonia at about 100° C. in the liquid phase. Diethylenetriamines and triethylenetetraamines are also produced by this reaction. Ethylene diamine can also be prepared by reacting monoethanolamine with ammonia and hydrogen over a nickel or cobalt catalyst at 150˜230° C. 1,2-diaminopropanes can be prepared by aminating a mixture of 2-amino-1-propanol and 1-amino-2-propanol.

A mixture of cis- and trans-1,2-diaminocyclohexane is produced by the hydrogenation of o-phenylenediamine. The racemic trans isomer [1:1 mixture of (1R,2R)-1,2-diaminocyclohexane and (1S,2S)-1,2-diaminocyclohexane] can be separated into the two enantiomers using enantiomerically pure tartaric acid as the resolving agent.

In one embodiment of a Formula II composition, the amine is a diethylenetriamine. A diethylenetriamine can be prepared as noted above in the process for making an ethylene diamine, or can be prepared by cyanoethylation of diaminoethane or a diaminopropane with acrylonitrile after which the product is hydrogenated.

In one embodiment of a Formula III composition, the amine is a piperazine such as 1-methylpiperazine. A piperazine is also obtained from the production of ethylene diamine by, for example, reacting ethanolamine with ammonia at 150-220° C., and distilling piperazine from the reaction mixture.

In one embodiment of a Formula IV composition, the amine is an imidazole such as 4,5-diaminomethylimidazole.

An imidazole can be prepared in the Debus synthesis by reacting glyoxal and formaldehyde in ammonia as follows:

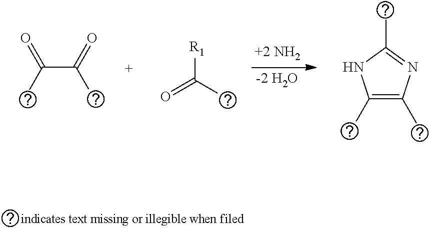

The (1,5) or (3,4) bond can be formed by the reaction of an imidate and an α-aminoaldehyde or α-aminoacetal, resulting in the cyclization of an amidine to imidazole, as shown below. R₁═R as described above, which could for example be hydrogen.

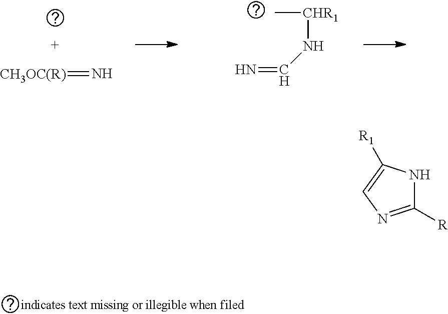

The (1,2) and (2,3) bonds can be formed by treating a 1,2-diaminoalkane, at high temperatures, with an alcohol, aldehyde, or carboxylic acid, as shown below. A dehydrogenating catalyst, such as platinum on alumina, is used. R₁, R₂ and R₃═R as described above.

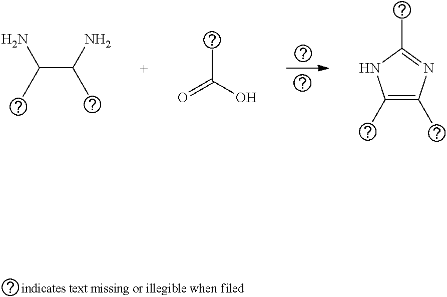

The (1,2) and (3,4) bonds can also be formed from N-substituted α-aminoketones and formamide with heat, as shown below. R₁=hydrogen.

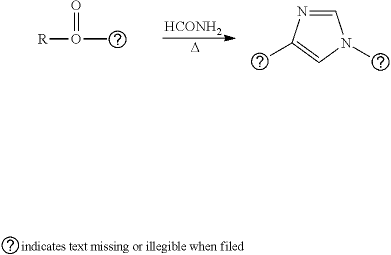

In another method, the starting materials are substituted glyoxal, aldehyde, amine, and ammonia or an ammonium salt, as shown below. R₁, R₂ and R₃═R as described above. R₄=hydrogen.

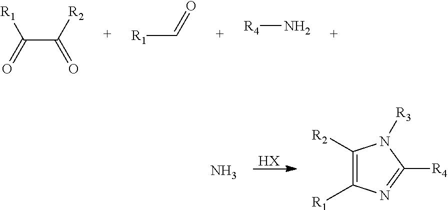

Imidazole can also be synthesized by the photolysis of 1-vinyltetrazole, as shown below, preferably with the use of an organotin compound such as 2-tributylstannyltetrazole. R₁ and R₂═R as described above.

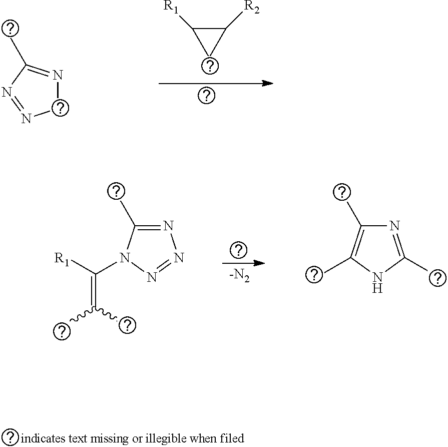

Imidazole can also be formed in a vapor phase reaction that occurs with formamide, ethylenediamine, and hydrogen over platinum on alumina at about 340 to 480° C.

In one embodiment of a Formula V composition, the amine is a triethlyenetetramine such as N,N,N′,N′-tetramethyltriethlyenetetramine. A triethylenetetraamine can be prepared as noted above in the process for making an ethylene diamine, or can be prepared by cyanoethylation of diaminoethane or a diaminopropane with acrylonitrile after which the product is hydrogenated.

In one embodiment, the compounds of Formula I, Formula II, Formula III, Formula IV or Formula V form a salt with HX, where HX is an acid with an acidic proton that forms a partially neutralized diamine, triamine or tetramine. The acid can be a mineral acid or a carboxylic acid. The acid may consist of, but is not limited to, HCl, H₂SO₄, H₃PO₄, HNO₃, acetic acid, propionic acid, trifluoroacetic acid, formic acid, oxalic acid, or any other acid capable of donating a proton to the parent amine.

Partial neutralization of the amine portion of a Formulae I˜V composition as used herein is accomplished by contacting the selected amine with a selected acid in an amount such that the ratio of moles of acid per mole of amine in a Formulae I˜IV composition is greater than about 0.1, or greater than about 0.2, or greater than about 0.3, or greater than about 0.4, and yet is less than about 0.7, or less than about 0.8, or less than about 0.9, or less than about 1.0. For a Formula V composition, the ratio of moles of acid per mole of amine is greater than about 0.2, or greater than about 0.4, or greater than about 0.6, or greater than about 0.8, and yet is less than about 1.4, or less than about 1.6, or less than about 1.8, or less than about 2.0.

The netralizaton reaction is typically run at a temperature that is greater than about 20° C., or greater than about 30° C., or greater than about 40° C., and yet is less than about 70° C., or less than about 80° C., or less than about 90° C. Temperature control can be achieved by slow addition of the acid to the base, dilution of either or both with water, and/or running in an ice or other chilled bath.

Examples of particular absorbents that are suitable for use in the methods and apparatus herein include those in the following table:

| Amine Compound | Anion from HX |
|---|---|
| 1,2-Diaminopropane | chloride |
| N,N-Diethyl ethylenediamine | chloride |
| 2-(Diisopropylamino) | chloride |
| ethylamine | |
| N,N′-Dimethyl | chloride |
| ethylenediamine | |
| N,N′-Diethyl ethylenediamine | chloride |
| N,N′-Diisopropyl | chloride |
| ethylenediamine | |
| N-Propyl ethylenediamine | chloride |
| N-Butyl ethylenediamine | chloride |
| N,N-Dimethyl-N′-ethyl | chloride |
| ethylenediamine | |
| 1,2-Diaminocyclohexane | chloride |
| Diethylenetriamine | chloride |
| N-(2-Aminoethyl)-1,3- | chloride |
| propanediamine | |
| N1-Isopropyl | chloride |
| diethylenetriamine | |
| Triethylenetetramine | chloride |
| Tris(2-aminoethyl) amine | chloride |
| Piperazine | chloride |
| 1-(2-Aminoethyl) piperazine | chloride |
| N,N,N′,N′-Tetramethyldiamino | chloride |
| methane | |
| 1,2-Diaminopropane | acetate |
| 1,2-Diaminocyclohexane | acetate |
| N,N-Dimethylethylenediamine | acetate |
| N,N-Diethylethylenediamine | acetate |
| 2- | acetate |
| (Diisopropylamino)ethylamine | |
| N,N′- | acetate |
| Dimethylethylenediamine | |
| N,N,N′- | acetate |
| Trimethylethylenediamine | |
| 3-(Dimethylamino)-1- | acetate |
| propylamine | |
| Diethylenetriamine | acetate |
| 1-(2-Aminoethyl)piperazine | acetate |
| Triethylenetetramine | acetate |
| Tris(2-aminoethyl)amine | acetate |
| 1-(2-Aminoethyl)piperidine | acetate |
| 4-(2-Aminoethyl)morpholine | acetate |
| N-(2- | acetate |
| Hydroxyethyl)ethylenediamine | |
| N,N-Diethylethylenetriamine | acetate |
| 1,2-Diaminopropane | phosphate |
| N,N-Dimethylethylenediamine | phosphate |
| N,N-Diethylethylenediamine | phosphate |
| N,N- | phosphate |
| Diisopropylethylenediamine | |
| N,N′- | phosphate |
| Dimethylethylenediamine | |
| N-Propylethylenediamine | phosphate |
| N,N,N′- | phosphate |
| Trimethylethylenediamine | |
| N,N-Dimethyl-N′- | phosphate |
| ethylethylenediamine | |
| 1,2-Diaminocyclohexane | phosphate |
| N,N-Diethylethylenetriamine | phosphate |
| 1-(2-aminoethyl)-pyrrolidine | phosphate |
| 1-(2-Aminoethyl)piperidine | phosphate |
| N-(2- | phosphate |
| Hydroxyethyl)ethylenediamine | |

The compositions described herein are thus useful for separation methods such as CO₂ absorption, adsorption, or other types of recovery. This can be accomplished by contacting a gaseous mixture containing CO₂ with one or more of the compositions represented by the structures of Formula I, Formula II, Formula III, Formula IV or Formula V as defined above. The compositions defined above may be used without dilution or with dilution as an aqueous or other solution.

Examples of gaseous mixtures containing CO₂ include without limitation flue gases, combustion exhausts, natural gas streams, streams from rebreathing apparatus, and the products of chemical synthesis, degradation or fermentation operations. The gases and gaseous mixtures referred to herein may include vapors (volatilized liquids), gaseous compounds and/or other gaseous elements.

Contacting the compositions of Formula I, Formula II, Formula III, Formula IV or Formula V as described or in solution with a gaseous mixture containing CO₂ may be accomplished by any means that promotes intimate mixing of the compositions with the source gas and is conducted for a time sufficient to allow significant removal of the targeted component(s). Thus, systems maximizing surface area contact are desirable. The conditions at which the process are conducted vary according to the compositions of the gaseous stream, the partial pressure of the CO₂, and equipment used, but in suitable embodiments be at temperatures ranging from ambient to about 200° C., and at pressures ranging from 1-5 atmospheres.

Illustratively, contacting the compositions of Formula I, Formula II, Formula III, Formula IV or Formula V as described or in solution with a gaseous mixture can be performed by use of conventional liquid absorbers, such as counter-current liquid absorbers or cyclone scrubbers, by permeation through a supported liquid membrane, or by use of a fixed bed.

In one embodiment herein, a liquid solvent can be used to remove a composition from a gas stream in an absorber, where gas and liquid are brought into contact countercurrently, and the gas is dissolved into the solvent. The absorber is typically equipped with trays or packing to provide a large liquid-gas contact area. Valve and sieve trays may be used, as may bubble cap and tunnel trays, where a tray typically has overflow weirs and downcomers to create hydrostatic holdup of the downward flow of the liquid. Random packings can also be used such as Rashig rings, Pall rings or Berl saddles, or structured packings of woven or nonwoven fabrics of metal, synthetic materials or ceramics.

The purified gas is taken off the head of the column. The solvent laden with the absorbed composition is withdrawn from the bottom of the absorber, routed to a regeneration system where it is freed of absorbed the absorbed gas component, and returned as lean solvent to the absorber. Regeneration may be accomplished by flash regeneration, which can involve pressure reduction and mild reboiling in one or more stages; by inert gas stripping; or by high temperature reboiling wherein the solvent is stripped by its own vapor, which is then condensed from the overhead gas and recycled as reflux.

In an absorber, a batch process may be performed where the flow rate through the vessel correlates to the residence time of contact and is suitably chosen to afford an effluent stream with the desired purification tolerance. To promote the desired intimate mixing, such gas/liquid absorption units also may be operated in a dual flow mode. Such dual flow can be co-current or counter-current. In such an embodiment, the gas mixture and the compositions of Formula I or Formula II flow through a purification unit contemporaneously. Methods for carbon dioxide absorption are further discussed in U.S. Pat. No. 6,579,343; US 2005/0129598; and US 2008/0236390 (each of which is by this reference incorporated as a part herein for all purposes).

Where supported liquid membranes are used for gas recovery, the membrane may include a solvent such as the compositions of Formula I, Formula II, Formula III, Formula IV or Formula V contained within the pores of a solid microporous support, such as a ceramic, metal, or polymeric support. Supported liquid membranes fabricated from supports such as ceramics, metals, and certain heat stable polymers may advantageously be used in higher than ambient temperature operations. Such higher temperature operations may be preferred to effect a more rapid separation, requiring less contact time. In addition, these higher temperature operations may also be a consequence of the process configuration, such as configurations requiring purification of high temperature exhaust gases or other gases exiting high temperature operations. Supported liquid membranes suitable for purifying high temperature gases obviate the need to pre-cool such gases before contact with the supported liquid membrane. The supported liquid membranes may be fabricated as thin films or hollow fibers with continuous networks of interconnected pores leading from one surface to the other. Supported liquid membranes contact a feed gas mixture on one side of the membrane and may effect separation of a gas component from the mixture by allowing that component to escape via permeation or diffusion into the compositions of Formula I, Formula II, Formula III, Formula IV or Formula V and through the liquid membrane.

The compositions of Formula I, Formula II, Formula III, Formula IV or Formula V can also be used in a conventional gas/liquid absorption unit-based system comprising a fixed bed. Such systems can be operated in batch mode or continuous flow mode. In a typical batch mode configuration, the compositions of Formula I, Formula II, Formula III, Formula IV or Formula V are introduced into a vessel followed by introduction of the gas mixture. After a prescribed residence time, the resulting gas is removed, leaving behind an impurity or group of impurities dissolved in the compositions of Formula I, Formula II, Formula III, Formula IV or Formula V. The batch purified gas can be generated by heating or reduced pressure treatment as described above. To maximize contact of the composition and the gas mixture, the compositions of Formula I, Formula II, Formula III, Formula IV or Formula V can be coated on a solid support, such as glass beads, and the like, to increase the surface area capable of contacting the gas mixture.

In one embodiment, this invention provides a method wherein the removal of CO₂ from a gaseous mixture occurs in a removal apparatus; wherein, in the removal apparatus, CO₂ is dissolved into a Formula I, Formula II, Formula III, Formula IV or Formula V composition(s) to form (i) a purified fraction that is depleted in CO₂ content (compared to the content therein in the original feed of the gaseous mixture) and (ii) a solvent fraction that is enriched in CO₂ content (compared to the content therein in the original feed of the gaseous mixture); and wherein the solvent fraction is separated from the removal apparatus. In a further alternative embodiment of the methods herein, CO₂ can be separated from the solvent fraction to form a rectified solvent fraction, and the rectified solvent fraction can be returned to the removal apparatus.

Equipment and processes that can be used for the absorption of CO₂ are further described in Absorption, Ullmann's Encyclopedia of Industrial Chemistry [2002, (Wiley-VCH Verlag GmbH & Co. KGa) Johann Schlauer and Manfred Kriebel, Jun. 15, 2000 (DOI: 10.1002/14356007.b03_{—}08)]; and Absorption, Kirk-Othmer Encyclopedia of Chemical Technology [2003, (John Wiley & Sons, Inc), Manuel Laso and Urs von Stockar (DOI:10.1002/0471238961.0102191519201503.a01.pub2)].

Various materials suitable for use herein may be made by processes known in the art, and/or are available commercially from suppliers such as Alfa Aesar (Ward Hill, Mass.), City Chemical (West Haven, Conn.), Fisher Scientific (Fairlawn, N.J.), Sigma-Aldrich (St. Louis, Mo.) or Stanford Materials (Aliso Viejo, Calif.).

Where a range of numerical values is recited or established herein, the range includes the endpoints therein and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value.

In this specification, unless explicitly stated otherwise or indicated to the contrary by the context of usage, where an embodiment of the subject matter herein is stated or described as comprising, including, containing, having, being composed of or being constituted by or of certain features or elements, one or more features or elements in addition to those explicitly stated or described may be present in the embodiment. An alternative embodiment of the subject matter herein, however, may be stated or described as consisting essentially of certain features or elements, in which embodiment features or elements that would materially alter the principle of operation or the distinguishing characteristics of the embodiment are not present therein. A further alternative embodiment of the subject matter herein may be stated or described as consisting of certain features or elements, in which embodiment, or in insubstantial variations therein, only the features or elements specifically stated or described are present.

Each of the formulae shown herein describes each and all of the separate, individual compounds and compositions that can be assembled in that formula by (1) selection from within the prescribed range for one of the variable radicals, substituents or numerical coefficents while all of the other variable radicals, substituents or numerical coefficents are held constant, and (2) performing in turn the same selection from within the prescribed range for each of the other variable radicals, substituents or numerical coefficents with the others being held constant. In addition to a selection made within the prescribed range for any of the variable radicals, substituents or numerical coefficents of only one of the members of the group described by the range, a plurality of compounds and compositions may be described by selecting more than one but less than all of the members of the whole group of radicals, substituents or numerical coefficents. When the selection made within the prescribed range for any of the variable radicals, substituents or numerical coefficents is a subgroup containing (i) only one of the members of the whole group described by the range, or (ii) more than one but less than all of the members of the whole group, the selected member(s) are selected by omitting those member(s) of the whole group that are not selected to form the subgroup. The compound, composition or plurality of compounds or compositions, may in such event be characterized by a definition of one or more of the variable radicals, substituents or numerical coefficents that refers to the whole group of the prescribed range for that variable but where the member(s) omitted to form the subgroup are absent from the whole group.

Other related systems, materials and methods for the removal of CO₂ from a gaseous mixture are disclosed in the following concurrently-filed U.S. provisional patent applications:

| | | |
|---|---|---|
| 61/313,298, | 61/414,532, | 61/416,421; |
| 61/313,173; | | |
| 61/313,181; | 61/313,322; | 61/313,328; |
| 61/313,312; | 61/313,183; and | 61/313,191; |

each of which is by this reference incorporated in its entirety as a part herein for all purposes.

What is claimed is:

1. A method of separating CO₂ from a first mixture of gases containing CO₂, comprising,
(a) contacting in an absorber, the first mixture of gases with an absorbent material that absorbs the CO₂ thereby separating the CO₂ from the first mixture and forming a second mixture comprising absorbed CO₂ and the absorbent material;
(b) heating in a stripper, the second mixture to a temperature sufficient to separate the CO₂ from the absorbent material to form released CO₂ and used absorbent material;
(c) increasing the pressure of the released CO₂ to a first pressure and a first temperature;
(d) cooling the released CO₂ of step (c) to a lower second temperature and extracting heat from the CO₂ during the cooling;
(e) recycling the used absorbent material back to the absorber; and
(f) applying the heat extracted during the cooling of the released CO₂ to provide at least a substantial portion of the heating requirements for operating the stripper and/or the absorber.

2. The method according to claim 1, further comprising cooling one or more of the first mixture, the absorbent material, or the second mixture.

3. The method according to claim 2, wherein the cooling is performed using an absorption cooler.

4. The method of claim 3 wherein at least a substantial portion of the heating requirements for operating the absorption cooler is provided by the heat extracted during the cooling of the released CO₂.

5. The method of claim 4, wherein the extracted heat is sufficient to provide all of the heating requirements for operating the absorption cooler.

6. The method of claim 1, wherein the extracted heat is sufficient to provide all of the heat required for operating the stripper.

7. The method of claim 1, wherein the extracted heat is sufficient to provide all of the energy required for operating the absorber.

8. The method according to claim 1, further comprising contacting the used absorbent material from step (b) with additional first mixture in step (a) to form additional second mixture.

9. The method according to claim 1, further comprising transferring thermal energy between the used absorbent material, as separated from CO₂ in step (b), and the second mixture in a heat exchanger.

10. The method according to claim 1, comprising further increasing the pressure of the CO₂ in step (c), thereby further increasing both the pressure and temperature of the CO₂ to a second temperature and second pressure.

11. The method according to claim 1, further comprising
(f) cooling one or more of the first mixture, the absorbent material, or the second mixture;
(g) increasing the pressure of the CO₂ at the first pressure, as obtained from step (c), to increase the pressure and temperature of the CO₂ a further pressure that is higher than the first pressure;
(h) cooling the CO₂ to reduce the further temperature to a lower resulting temperature, and to extract heat from the CO₂; and
(i) applying the heat extracted from the cooled CO₂
to the step (b) of heating the second mixture, and/or to the step (f) of cooling one or more of the first mixture, the absorbent material, or the second mixture.

12. The method according to claim 1, wherein the first mixture of gases is produced by a combustion reaction.

13. A method of separating CO₂ from a first mixture of gases containing CO₂, comprising
(a) contacting the first mixture of gases with an absorbent material that absorbs the CO₂ thereby separating it from the first mixture, thereby forming a second mixture comprising absorbed CO₂ and the absorbent material;
(b) applying an amount of cooling Qₒᵤₜ, to cool one or more of the first mixture, the absorbent material and/or the second mixture;
(c) applying an amount of heat Qᵢₙ to heat the second mixture to separate the absorbed CO₂ from the absorbent material to form released CO₂; and
(d) increasing the pressure of the released CO₂, to a pressure whereby, when the released CO₂ is cooled to reduce its temperature and to extract heat therefrom, the extracted heat (Qₐᵥₐᵢₗ) satisfying the equation
Qₐᵥₐᵢₗ>F×(Qᵢₙ−Qₒᵤₜ/COP);
wherein F is a percentage, greater than or equal to 50%, or greater than or equal to 60%, or even greater than or equal to 70%, or preferably greater than or equal to 80%, or more preferably greater than or equal to 90%, or even more preferably greater than or equal to 100%.

14. The method of claim 13, wherein F is greater than or equal to 50%.

15. The method of claim 13, wherein F is greater than or equal to 60%.

16. The method of claim 13, wherein F is greater than or equal to 70%.

17. The method of claim 13, wherein F is greater than or equal to 80%.

18. The method of claim 13, wherein F is greater than or equal to 90%.

19. The method of claim 13, wherein F is greater than or equal to 100%.

20. An apparatus for separating CO₂ from a first mixture of gases containing CO₂, comprising;
(a) an absorber comprising an absorbent material for absorbing CO₂, wherein the CO₂ is separated from the first mixture thereby forming a second mixture comprising absorbed CO₂ and the absorbent material;
(b) a separator for heating the second mixture to a temperature sufficient for releasing the absorbed CO₂ from the absorbent material thereby providing released CO₂;
(c) at least one compressor to compress the released CO₂ thereby increasing the pressure and temperature of the CO₂;
(d) at least one cooler for reducing the temperature of the CO₂ to provide cooled CO₂, and extracting heat therefrom; and
(e) a thermal energy transfer medium for applying the heat extracted from the cooled CO₂ to one or more of the absorber or the separator.

21. The apparatus according to claim 20, further comprising an absorption cooler to cool one or more of the first mixture, the absorbent material or the second mixture.

22. The apparatus according to claim 20, further comprising a thermal energy transfer medium to apply the heat extracted from the cooled CO₂ to the absorption cooler.

23. The apparatus according to claim 20, further comprising a recycle conduit to provide absorbent material, as separated from CO₂ in the separator, to the absorber.

24. The apparatus according to claim 20, further comprising a recycle conduit to provide used absorbent material, as separated from CO₂ in the separator, to the absorber; and a flow conduit in which the second mixture flows from the absorber to the separator; wherein the recycle conduit is positioned relative to the flow conduit to affect thermal energy transfer between the absorbent material and the second mixture.

25. A method of separating CO₂ from a first mixture of gases containing CO₂, comprising,
(a) contacting a first mixture of gases with an absorbent material that absorbs the CO₂ thereby separating the CO₂ from the first mixture and forming a second mixture comprising absorbed CO₂ and the absorbent material;
(b) heating the second mixture to a temperature sufficient to separate the CO₂ from the absorbent material to form released CO₂ and used absorbent material;
(c) increasing the pressure of the released CO₂ to a first pressure and a first temperature;
(d) cooling the released CO₂ of step (c) to a lower second temperature and extracting heat from the CO₂ during the cooling; and
(e) applying the heat extracted during the cooling of the CO₂ to provide at least a substantial portion of the energy required to heat the second mixture, and to cool the used absorbent material.

26. The method of claim 25, wherein the heat extracted during the cooling of the CO₂ is sufficient to meet the heating requirements needed to separate the CO₂ from the absorbent material.

27. The method of claim 25, wherein the heat extracted during the cooling of the CO₂ is sufficient to cool the used absorbent.

28. The method of claim 25, wherein the heat extracted during the cooling of the CO₂ is sufficient to heat the second mixture and cool the used absorbent.
